(19) United States
(12) Patent Application Publication
(10) Pub. No.: US 2012/0049424 A1
(43) Pub. Date: Mar. 1, 2012

(54) ELECTRONICALLY SWITCHABLE BI-STATE ENGINE MOUNT

(76) Inventors: Jeff Bradshaw, Bloomfield, MI (US); Andrew Hartgers, Ilderton (CA)

(21) Appl. No.: 13/140,898

(22) PCT Filed: Dec. 18, 2009
(86) PCT No.: PCT/US09/68800

§ 371 Date: Nov. 7, 2011

Related U.S. Application Data
(60) Provisional application No. 61/138,700, filed on Dec. 18, 2008.

(51) Int. Cl. F16F 13/26; F16F 13/10; B23P 19/00

(52) U.S. Cl. 267/140.14; 29/428

(57) ABSTRACT

An electronically switchable bi-state engine mount includes a housing having an inertia track received in the housing between first and second fluid chambers. A fluid damped first path communicates between the chambers, and a non-damped second path or bypass opening also communicates between the chambers. A diaphragm encloses a portion of the second fluid chamber and a seal member on the diaphragm operatively cooperates with a solenoid plunger, where the solenoid is received in the housing to selectively open and close the second path. The diaphragm is enclosed by a cover, which is preferably metal, to enhance thermal conductivity and heat sink properties thereof and improve the useful life of the solenoid.

This application claims priority from U.S. Provisional Patent Application Ser. No. 61/138,700, filed 18 Dec. 2008, the disclosure of which is hereby expressly incorporated herein by reference.

### BACKGROUND OF THE DISCLOSURE

This disclosure relates to a damper assembly, and more specifically to a switchable hydraulic engine mount that suspends a vehicle powertrain, provides damping to powertrain motion, controls the powertrain travel, and isolates the powertrain from the vehicle chassis.

As with most switchable hydraulic engine mounts, a switch mechanism allows the mount to switch between two states, typically one with fluid effect damping, and the other with no, or reduced, fluid effect damping. The basic technology for switchable hydraulic engine mounts has been known in the industry for several years. Physical switching of a hydraulic mount from a fluid damped state to a non-damped state by way of opening and closing a port is well understood. However, there are multiple methods by which this can be achieved.

Most of the electrical switching hardware is mounted externally for ease of manufacture. Unfortunately, external mounting of the switching hardware tends to reduce the efficiency of the mount response. On the other hand, external mounting of the switching hardware allows for easier sealing of the hydraulic fluid. A problem with many conventional designs is the use of a diaphragm with an air spring under the diaphragm attached to an external port. Opening and closing this external port is the method used to “switch” a mount state from a fluid damped state to a non-damped state, or vice-versa. In the open port state, air can be pumped to atmosphere. In the closed port state, the air acts as a stiff spring. The air spring created by the closed port reduces the pressure of the fluid that would otherwise be pumped through an inertia track because some of the fluid pressure is used to compress the air spring.

Other designs use a rotary valve to open and close the port. These rotary valves can rotate either axially or radially with the mount. In either case, sealing of the valve can become an issue, where it is difficult to seal from either the low pressure side of the mount to high, or from the high pressure side of the mount to atmosphere. Such a design requires more moving parts and can be prone to failure. Further, the rotary valve requires additional thickness at the port location to compensate for the rotary mechanism. Neither the additional complexity nor the additional port thickness is desired.

### SUMMARY OF THE DISCLOSURE

An electronically switchable damper assembly, or switchable bi-state engine mount, includes a housing having a dividing wall such as an inertia track that separates the housing into first and second fluid chambers. The first and second chambers communicate via a fluid damped first path and a non-damped second path or bypass opening. A movable wall or diaphragm encloses a portion of the second fluid chamber. A solenoid received in the housing is operatively associated with a seal member to selectively open and close the bypass opening.

The solenoid includes a plunger that is extended and retracted in response to energization and deenergization of a solenoid coil. The plunger advances and retracts the seal member mounted on the diaphragm to close/open the bypass opening.

A cover extends in protective relation and encloses a portion of the diaphragm.

The cover is preferably a rigid structure and defines or includes a heat sink in thermal contact with the solenoid.

A method of assembling an engine mount includes supplying a housing having a first inertia track that divides the housing into a first fluid chamber on a first side and a second fluid chamber on a second side. A fluid damped first path communicates between the chambers and a non-damped second path communicates between the same chambers.

The method further includes closing a portion of the second fluid chamber with a diaphragm, locating a solenoid in the housing, and positioning a seal member for movement by the solenoid to selectively open and close the second path.

The method further includes placing the solenoid in communication with a heat sink portion of a protective cover.

A primary benefit of this disclosure is associated with mounting the solenoid internally in the mount to protect the solenoid from heat, debris, and damage.

Another benefit is associated with the improvement in overall dynamic response of the mount.

Still another advantage resides in directly actuating the fluid bypass port.

Still, other features and benefits of the invention will become apparent to those skilled in the art upon reading and understanding the following, detailed description.

### BRIEF DESCRIPTION OF THE DRAWINGS

FIG. 1 is a cross-sectional view of an assembled electronically switchable damper assembly or electronically switchable bi-state engine mount.

FIG. 2 is a perspective view of the mount assembly of FIG. 1 taken generally from the bottom portion thereof.

FIG. 3 is a perspective view of the engine mount of FIGS. 1 and 2 taken generally from the upper, left-hand portion.

### DETAILED DESCRIPTION OF THE PREFERRED EMBODIMENT

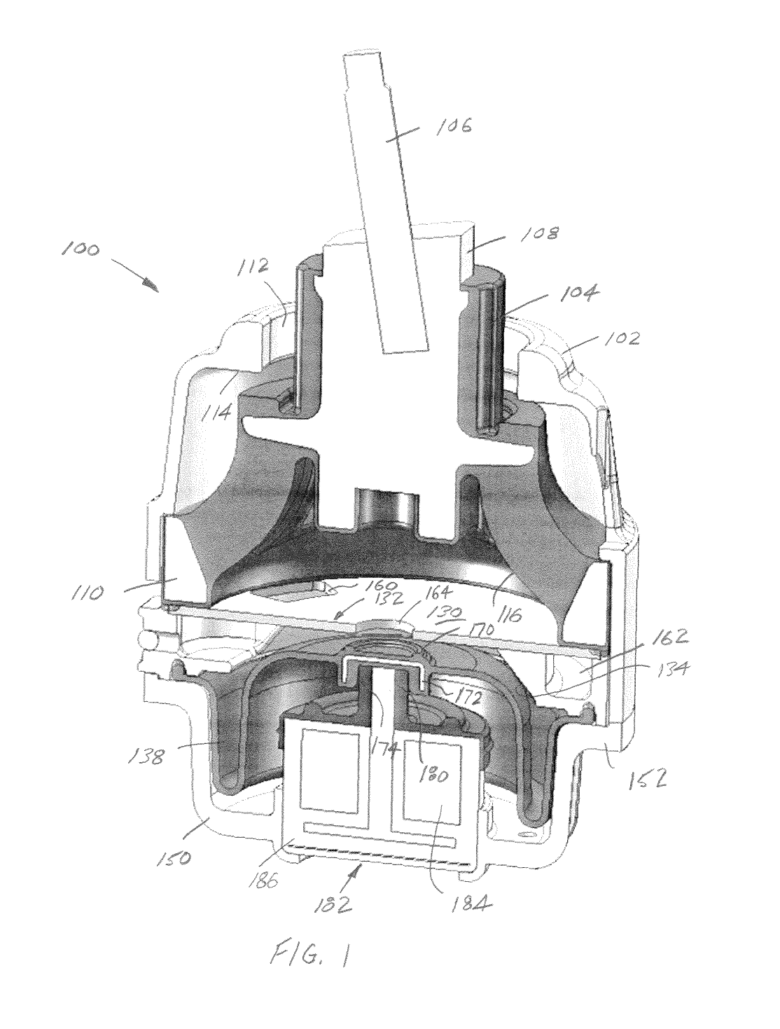

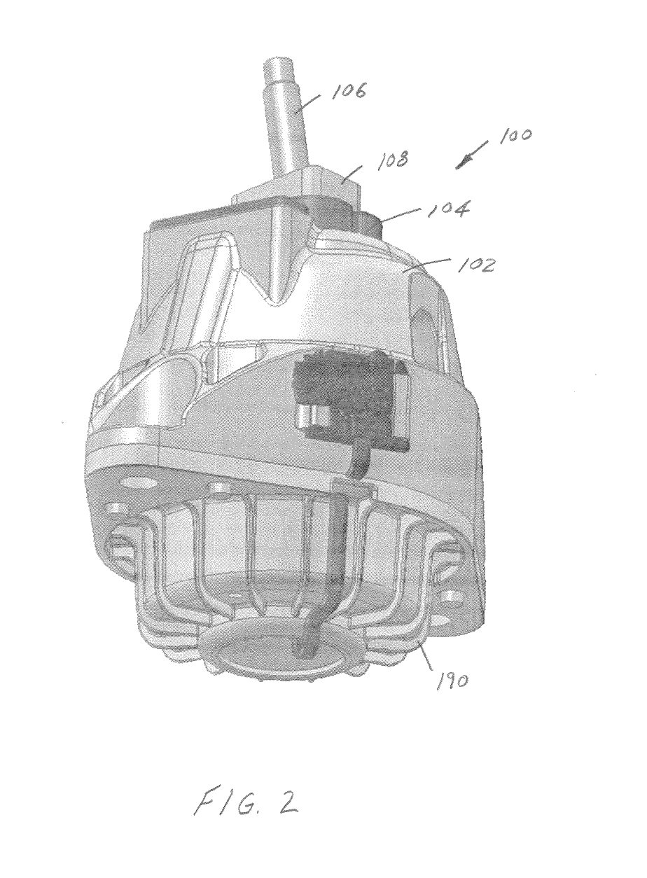

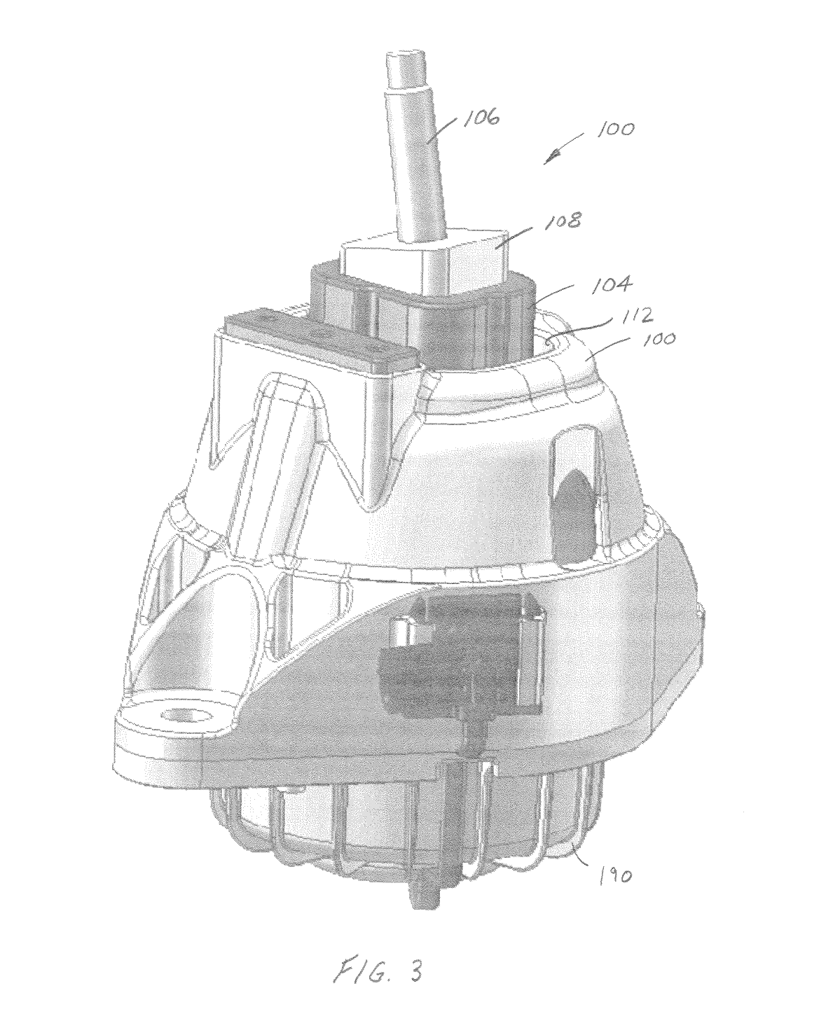

FIGS. 1-3 show a damper assembly for engine mount 100, particularly the type that suspends powertrain and isolates the powertrain from the vehicle chassis. The assembly includes a restrictor or external housing 102 dimensioned to receive a first or elastomeric component, sometimes referred to as the main rubber element or compliant member 104. The main rubber element has a general shape of a truncated cone and is made of an elastomeric material such as elastic rubber. A fastener 106 extends outwardly from a metal bearing member 108 that is at least partially encapsulated within the first elastomeric member 104. As best shown in FIG. 1, a lower portion of the rubber element 104 includes a stiffener such as metallic stiffener 110 that is typically molded within the rubber element to add rigidity and support at desired locations.

The rubber element is received within the restrictor housing so that the fastener extends through a central opening 112 of the restrictor. An internal shoulder 114 of the restrictor abuttingly engages the lower portion of the main rubber element. Further, the lower portion of the main rubber element is hollowed out to define a surface of a first or upper fluid chamber 116. A dividing wall or inertia track assembly 130 seals along an outer perimeter region with a lower surface of the main rubber element 104. In this manner, the first fluid chamber is defined by the cavity formed between the main rubber element 104 and the inertia track 130. The inertia track has a first or upper surface 132 that faces the first chamber and a second or lower surface 134 that cooperates with a movable wall or diaphragm 135 preferably formed from a flexible rubber material that is sealed along an outer periphery with the inertia track assembly. In this manner, the inertia track assembly, namely the lower surface 134 thereof, and the diaphragm define the second chamber 138.

In addition, a protective cover 150, sometimes referred to as a diaphragm cover, extends in protective relation over the diaphragm, i.e., the cover encloses a portion of the diaphragm. The cover 150 also has a perimeter portion 152 that seals against the perimeter of the inertia track assembly 130 and also with the outer perimeter of the diaphragm 136. In this manner, the perimeter portions of the restrictor 102, main rubber element 104, inertia track assembly 130, diaphragm 136, and the protective cover 150 are all clampingly and sealingly engaged together to seal the first and second fluid chambers 116, 138 from the external environment.

The inertia track assembly that divides the first and second fluid chambers 116, 138 includes two paths that communicate between the chambers. A fluid damped first path includes an opening 160 through the upper surface 132 of the inertia track assembly and an elongated, restrictive path 162, that ultimately communicates through an opening (not shown) in the lower surface 134 of the inertia track assembly that enters or opens into the lower fluid chamber 138. The elongated nature of the first path serves to damp fluid vibrations in response to forces and vibrations imposed on the main rubber element 104.

In addition, an undamped, second path is defined by opening or bypass opening 164, shown in the embodiment of FIG. 1 as a centrally located opening in the inertia track assembly that communicates between the first and second fluid chambers 116, 138. The bypass opening 164 provides for direct communication between the first and second fluid chambers, and is selectively opened and closed by a seal member 170. Here, the seal member may be a port seal formed on the diaphragm, preferably integrally formed as a part of the diaphragm 136 and dimensioned to seal about the opening 164, preferably on the under surface 134 of the inertia track assembly. A reinforcement member 172 may preferably be encapsulated within the diaphragm adjacent the seal member, and is illustrated as a generally inverted U-shape in cross-section. The reinforcement member 172 and seal member form a cup-shape or recess 174 on the lower surface of the diaphragm that faces the cover 150. The recess 174 is dimensioned to receive a terminal end of a solenoid plunger 180 that extends axially outward from solenoid 182. The solenoid also includes a coil portion 184. Selective energization of the coil 184 extends and retracts the plunger 180 relative to the solenoid body.

In this preferred embodiment, solenoid 182 is supported by or mounted at one end 186 in the protective cover 150. The solenoid 182 is protected by the cover 150, and preferably oriented so that the directional axis of plunger movement is substantially aligned with a central axis of the bypass opening 164. This protected interior location of the solenoid within the cover protects the important switching mechanism/hardware from debris or damage. The location also allows the solenoid plunger that is operatively engaged with seal member 170, and seated within the recess 174 thereof, to advance and retract relative to bypass opening 164. The overall dynamic response of the mount is significantly improved. When the bypass opening 164 is not sealed, there is no or reduced fluid effect damping. On the other hand, when the seal member 170 closes the second path or bypass opening 164 upon extension of the solenoid plunger, fluid communicates between the first and second chambers through the elongated inertia track 162.

With the solenoid internally located in the engine mount, the seal member is directly actuated to engage the diaphragm port seat and open or close the bypass port 164. This forces fluid from the compliant side (first fluid chamber 116) of the mount to either travel through the inertia track 164 and create fluid effect damping in the closed state, or alternatively through the bypass port if it is in the open state, which has little or no fluid effect damping.

The internally mounted solenoid improves on existing designs by direct actuation sealing of the bypass port. This arrangement for opening and closing the bypass port also improves on existing designs by increasing the switching response time of the mount. When the solenoid plunger is extended to seal or close the bypass port 164, the solenoid plunger is in an extended, closed state where the plunger generates its greatest holding force. This elevated holding force prevents fluid pressure from the compliant side of the mount from overcoming the bypass port seal. In general, this results in an improved structure relative to many current designs because the engine mount does not use a decoupler and air spring as the switching member.

The internal mounted design also improves on current designs by preventing damage to the solenoid 182. If the mount 100 is inadvertently dropped during handling or assembly, an externally mounted solenoid would otherwise be at risk and be easily damaged.

In addition, the externally mounted solenoid of current arrangements potentially exposes the solenoid to road debris and direct radiant heat. These issues are overcome with mounting of the solenoid 182 within the mount assembly 100 and providing the protective function of the cover 150.

Still another benefit is the provision of heat transfer or cooling fins 190 that are provided on an external surface of the cover. Since the diaphragm cover is typically formed of a rigid material such as metal, the cover can also be advantageously used for its thermally conductive properties. In this manner, heat generated by coil energization of the solenoid is thermally conducted to the cooling fins 190. Stated another way, the cooling fins 190 allow a portion of the protective cover to serve as a heat sink. This increases the life expectancy of the solenoid.

The above-described engine mount assembly is designed to operate at temperatures between approximately −40° C. to approximately 120° C. The solenoid is easily pressed into or retained by the diaphragm cover where the solenoid is in physical or thermally conductive contact with the cover. Again, the thermal conductivity of the cover, typically a metal, acts as a heat sink and particularly the cooling fins enhance the heat sink properties.

The engine mount is intended for use with cars, trucks, off-road vehicles, and other heavy equipment. The vibrations produced by the powertrain necessitate the need for a two state or bi-state hydraulic mount. These engine mount assemblies find particular application where a soft, highly isolated mount is required to isolate high disturbance idle vibration, but where a stiff, highly damped mount is required for vehicle drive events. Modern diesels, direct inject and homogenous charge compression ignition (HCCI) gas engines, can all benefit from the engine mount assembly of the present disclosure. Moreover, engines that exhibit high idle instability but that are typically used in high-end vehicle applications where a well-damped ride is required can also effectively employ the above described engine mount assembly.

The location of the solenoid within the mount provides for direct actuation of the solenoid plunger on the bypass port. The diaphragm is used as the spring pressure to open the bypass port when the solenoid is deenergized. Further, the gap between the diaphragm seal and the bypass port can be adjusted to increase or decrease fluid flow through the port as desired.

The disclosure has been described with reference to the preferred embodiment. Modifications and alterations will occur to others upon reading and understanding this specification. For example, the seal and solenoid plunger could be arranged in a manner that allows the seal to engage the upper, first surface of the bypass opening, or add a spring to the assembly in which the spring force holds the seal member against the bypass port and energizing the coil overcomes the spring force to open the bypass port. It is intended to include all such modifications and alterations in so far as they come within the scope of the appended claims or the equivalents thereof.

Having thus described the invention, we claim:

1. An electronically switchable damper assembly comprising:
a housing having a dividing wall that separates first and second chambers in selective fluid communication with each other via a bypass opening and an elongated path;
a movable wall disposed on one side of the dividing wall that forms the second chamber therebetween;
a solenoid received in the housing; and
a seal member operatively associated with the solenoid and actuated thereby to selectively open or close the bypass opening.

2. The assembly of claim 1 wherein the movable wall is formed of a flexible material for expanding or reducing a volume of the second chamber in response to fluid entering or exiting the second chamber, respectively.

3. The assembly of claim 1 wherein the solenoid includes a plunger that is extended or retracted in response to energization or deenergization of a coil.

4. The assembly of claim 3 wherein the solenoid plunger operatively engages the seal member to engage and disengage the seal member with the bypass opening.

5. The assembly of claim 4 further comprising a cover that extends in protective relation over the movable wall and the solenoid.

6. The assembly of claim 5 wherein the cover is a substantially rigid material that mounts the solenoid relative to the bypass opening.

7. The assembly of claim 6 wherein the cover includes a cooling surface that serves as a heat sink for heat generated by the solenoid coil.

8. The assembly of claim 4 wherein the seal member is secured to the movable wall.

9. The assembly of claim 8 wherein an axis of movement of the plunger is substantially aligned with an axis of the bypass opening.

10. An electronically switchable bi-state engine mount comprising:
a housing;
an inertia track received in the housing that divides the housing into a first fluid chamber on a first side and a second fluid chamber on a second side, and an elongated fluid damped first path that communicates between the first and second fluid chambers and a non-damped second path that communicates between the first and second fluid chambers;
a diaphragm enclosing a portion of the second fluid chamber;
a solenoid received in the housing; and
a seal member operatively engaged by the solenoid for selectively opening and closing the second path.

11. The engine mount of claim 10 wherein the seal member is secured to the diaphragm.

12. The engine mount of claim 10 wherein the solenoid includes a plunger that is selectively extended/retracted via selective energization/deenergization of a coil, and movement of the plunger advances/recedes the seal member to close/open the second path.

13. The engine mount of claim 10 further comprising a diaphragm cover that encloses a portion of the diaphragm.

14. The engine mount of claim 13 wherein the diaphragm cover is a rigid structure.

15. The engine mount of claim 13 further comprising a heat sink on the diaphragm cover in thermal contact with the solenoid.

16. The engine mount of claim 13 wherein the solenoid is supported by the diaphragm cover adjacent the diaphragm.

17. The engine mount of claim 16 wherein the solenoid includes a plunger that is selectively extended/retracted via selective energization/deenergization of a coil, and movement of the plunger advances/recedes the seal member mounted on the diaphragm to close/open an opening in the inertia track that forms the second path.

18. A method of assembling an engine mount comprising:
supplying a housing having an inertia track that divides the housing into a first fluid chamber on a first side and a second fluid chamber on a second side, and an elongated fluid damped first path the communicates between the first and second fluid chambers and a non-damped second path that communicates between the first and second fluid chambers;
enclosing a portion of the second fluid chamber with a diaphragm;
locating a solenoid in the housing; and
positioning a seal member for movement by the solenoid to selectively open and close the second path.

19. The method of claim 18 further comprising enclosing a portion of the diaphragm with a cover.

20. The method of claim 19 further comprising placing the solenoid in thermal communication with a heat sink portion of the cover.
